(19) United States
(12) Patent Application Publication
(10) Pub. No.: US 2017/0252236 A1
(43) Pub. Date: Sep. 7, 2017

(54) MOBILITY ASSISTANCE OFFICE CHAIR

(71) Applicant: Troy Technologies Inc., Torrance, CA (US)

(72) Inventor: Nathan Anthony Watkins, Hermosa Beach, CA (US)

(21) Appl. No.: 15/446,239

(22) Filed: Mar. 1, 2017

Related U.S. Application Data
(60) Provisional application No. 62/303,005, filed on Mar. 3, 2016.

(51) Int. Cl. A61G 5/02; A61G 5/10; A61G 5/12; A47C 7/00

(52) U.S. Cl. CPC A61G 5/02; A47C 7/004; A47C 7/006; A61G 5/1059; A61G 5/125; A61G 5/122; A61G 5/1054

(57) ABSTRACT

A mobility assistance office chair, comprising: a wheelbase; a first set of wheels; a second set of wheels; a seatbase; a seat bottom; and a seat back. The second set of wheels has a radius that is long enough to allow a top portion of said second set of wheels to be within arm's reach of a user seated on the seat bottom, such that said user may manually use said second set of wheels to cause said mobility assistance office chair to move as powered by said user. The seat back may have an appearance of being an office chair seat back.

### CROSS-REFERENCE TO RELATED APPLICATIONS

This U.S. Non-Provisional Patent Application claims the benefit of U.S. Provisional Patent Application No. 62/303,005, filed Mar. 3, 2016, entitled “CHAIR WITH WHEELS”, the contents of which are expressly incorporated herein by this reference as though set forth in their entirety.

### FIELD OF USE

The present disclosure generally relates to the field of chairs with wheels. More specifically, the present disclosure generally relates to a chair with wheels suitable for use in an office or home environment.

### BACKGROUND

People with mobility restriction issues generally use a mobility assistance device to more effectively get around, but in many situations, the mobility assistance devices that they use are visible, such that a user of a mobility assistance device is immediately recognizable as requiring the mobility assistance device.

One common mobility assistance device is a conventional wheelchair. A conventional wheelchair is generally bulky with a limited amount of model availability and adjustability. Conventional wheelchairs are also readily apparent as a wheelchair to an observer when in use. Conventional wheelchairs do not typically have the range of adjustability or comfort present in chairs commonly used in an office environment.

A user with mobility issues may also have difficulty using a standard office chair due to the limited manner in which an office chair may be moved, which is generally done by scooting using one's feet.

There is a growing population of aging baby boomers who have limited mobility but may not prefer using conventional wheelchairs for personal and esthetic reasons. Additionally, wheelchairs are specifically designed for individuals who do not have full use of their legs. But there are individuals that still have some use of their legs, and traditional wheelchairs can interfere with those individual's limited leg use.

Accordingly, what is needed is a new chair with wheels, which is suitable for use by mobility restricted individuals for use in the office and home.

### SUMMARY

To minimize the limitations in the prior art, and to minimize other limitations that will become apparent upon reading and understanding the present specification, the present specification discloses a mobility assistance office chair.

One embodiment may be a chair with wheels, comprising: portions of office chairs; and portions of wheelchairs; wherein said wheel with chairs has the mobility offered by a wheelchair, but the form factor and function of an office chair.

Another embodiment of the mobility assistance office chair may comprise: a wheelbase; a first set of wheels; a second set of wheels; a seatbase; a seat bottom; and a seat back. The first set of wheels and the second set of wheels may be connected to the wheelbase. The seatbase may be a substantially vertical and connects the wheelbase to the seat bottom. The seatbase, the seat bottom, and the wheelbase may be substantially static with respect to each other, such that the seat bottom and the wheelbase do not rotate relative to each other. The second set of wheels may have a radius that may be long enough to allow a top portion of the second set of wheels to be within arm's reach of a user seated on the seat bottom, such that the user may manually use the second set of wheels to cause the mobility assistance office chair to move as powered by the user. The seat back preferably has an appearance of being an office chair seat back. The mobility assistance office chair may be configured to allow a person with impaired mobility to be mobile within an office environment. The seat back may be adjustable. The seat bottom may be adjustable. The seat bottom height, relative to the wheelbase, may be adjustable. The mobility assistance office chair may further comprise one or more arm rests, which may be adjustable. The wheelbase may comprise four arms that may be connected to the first set of wheels and the second set of wheels. The first set of wheels may comprise a set of rotatable casters. The set of rotatable casters may provide balance and support to the mobility assistance office chair, and wherein the second set of wheels substantially bears the weight of the mobility assistance office chair and the user when in use. The wheelbase may be substantially horizontal and substantially cross-shaped. Each wheel of the second set of wheels may comprise a hand gripping portion.

Another embodiment may be a mobility assistance office chair, comprising: a wheelbase; a first set of wheels; a second set of wheels; a seatbase; a seat bottom; and a seat back. The first set of wheels and the second set of wheels may be connected to the wheelbase. The seatbase may be a substantially vertical and connects the wheelbase to the seat bottom. The seatbase, the seat bottom, and the wheelbase may be substantially static with respect to each other such that the seat bottom and the wheelbase do not rotate relative to each other. The second set of wheels may have a radius that may be long enough to allow a top portion of the second set of wheels to be within arm's reach of a user seated on the seat bottom, such that the user may manually use the second set of wheels to cause the mobility assistance office chair to move as powered by the user. The seat back has an appearance of being an office chair seat back. The mobility assistance office chair may allow a person with impaired mobility to be mobile within an office environment. The seat back and seat bottom may be adjustable. The mobility assistance office chair may further comprise one or more arm rests, which may be adjustable. The wheelbase may comprise four arms that may be connected to the first set of wheels and the second set of wheels. The first set of wheels may comprise a set of rotatable casters, which may provide balance and support. Preferably, the second set of wheels substantially bears the weight of the mobility assistance office chair and the user when in use. Each wheel of the second set of wheels may comprise a hand gripping portion.

It is an object to overcome the deficiencies of the prior art.

These, as well as other components, steps, features, objects, benefits, and advantages, will now become clear from a review of the following detailed description of illustrative embodiments, and of the claim.

### BRIEF DESCRIPTION OF THE DRAWINGS

The accompanying drawings incorporated herein and forming a part of the specification illustrate example embodiments.

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is a front view of one embodiment of a mobility assistance office chair.

FIG. 2 is a rear view of one embodiment of a mobility assistance office chair.

FIG. 3 is a side view of one embodiment of a mobility assistance office chair.

FIG. 4 is a front view of another embodiment of a narrow mobility assistance office chair.

FIGS. 5A-D are different views of wheelbases for use with a mobility assistance office chair.

### DETAILED DESCRIPTION OF ILLUSTRATIVE EMBODIMENTS

In the following detailed description of various embodiments, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments of the present disclosure.

While multiple embodiments are disclosed, other embodiments will become apparent to those skilled in the art from the following detailed description, which shows and describes illustrative embodiments. As will be realized, the system and method described herein is capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment of the disclosure shall not be interpreted to limit the scope of the disclosure.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

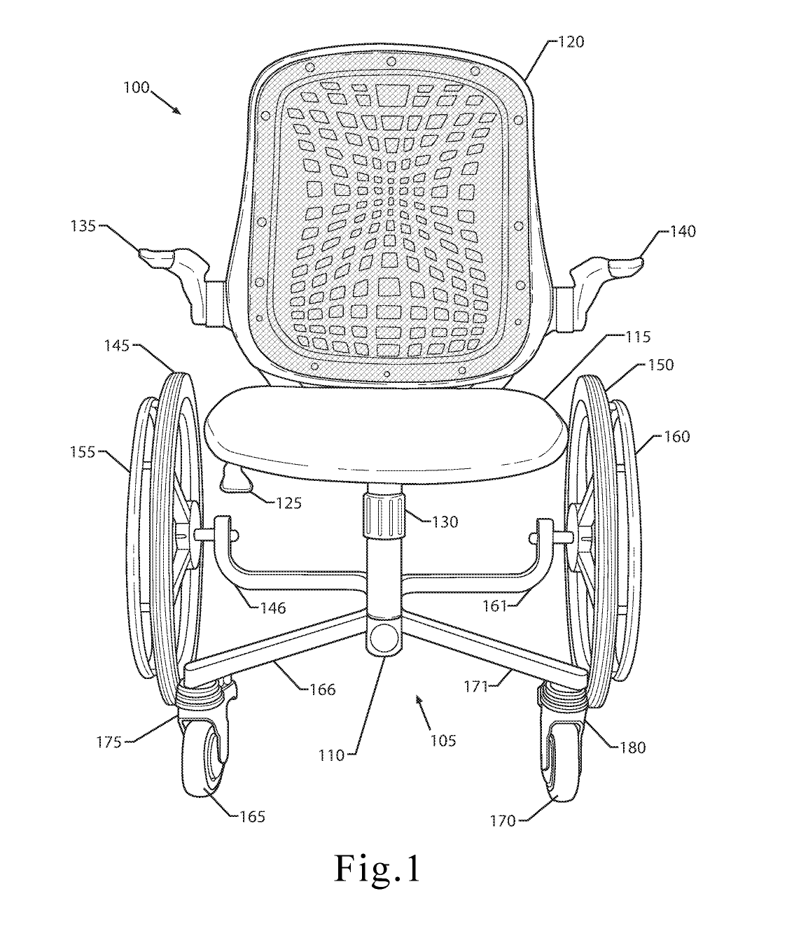

FIG. 1 is a front view of one embodiment of a wheelchair. As shown in FIG. 1, the mobility assistance office chair 100 may comprise a wheelbase 105, seatbase 110, seat bottom 115, seat back 120, a first set of wheels 165, 170, and a second set of wheels 145, 150. The arms 146, 161, 166, 171 of the wheelbase 105 may connect to the first set of wheels 165, 170 and second set of wheels 145, 150. The wheelbase 105 may comprise the seatbase 110, wherein the seatbase 110 may be a substantially cylindrical shape, and may preferably connect to the seat bottom 115 at or near a substantially center portion of the seat bottom 115. Alternatively, the seatbase 110 may be any shape and/or substantially vertical structure connecting the wheelbase 105 to the seat bottom 115. The seatbase 110 may be fixed and non-rotatable relative to the seat bottom 115 and the wheelbase 105. The seatbase 110 preferably connects to the seat bottom 115 near a substantially center portion of the seat bottom 115 in order to increase similarity of appearance to a traditional office chair and minimize structural components that may interfere with how a user may use the mobility assistance office chair 100.

The first set of wheels 165, 170 may comprise a front right wheel 165 and a front left wheel 170. The first set of wheels 165, 170 may comprise to a set of casters 175, 180 and the set of casters 175, 180 may then connect to the ends of two arms 166, 171 of the wheelbase 105. The set of casters 175, 180 may preferably be five-inch medical grade rotatable casters and may be lockable. The casters 175, 180 may also be any other relatively small size caster for the purpose of providing stability and maneuverability.

The second set of wheels 145, 150 may comprise a rear right wheel 145 and a rear left wheel 150. The second set of wheels 165, 170 may connect to the ends of two arms 146, 161 of the wheelbase 105. The wheelbase 105 may form a cross shape, wherein the seatbase 110 may be located near or attached to an intersection portion of the cross shape. The four arms 146, 161, 166, 171 may, on one end, connect to the wheels 145, 160, 165, 170 and on their other end, connect to one another 146, 161, 166, 171 or the seatbase 110.

The second set of wheels 165, 170 may comprise hand gripping portions 155, 160. The hand gripping portions 155, 160 may be located such that a sitting user would be able to comfortably reach the hand gripping portions 155, 160 and effectively propel themselves, forward or backward, by moving the hand gripping portions 155, 160 to turn the second set of wheels 165, 170. The hand gripping portions 155, 160 may be ring structures attached to the second set of wheels 165, 170 that allow a user to push or pull on the hand gripping portion 155, 160 in order to turn the second set of wheels 165, 170. As shown in FIG. 1, the second set of wheels 165, 170 may be large medical grade wheelchair-type wheels, and may be twenty inches in diameter, which would allow a user to traverse small obstacles, entryways, and multiple types of flooring. The second set of wheels 165, 170 may be any other relatively larger sized wheels.

The mobility assistance office chair 100 may also comprise an adjustable seat height mechanism, such as a pneumatic system, which allows the user raise and lower the height of the seat relative to wheels 165, 170. The seat height mechanism, may comprise a seat height adjuster 125. Additionally, the mobility assistance office chair 100 may comprise a tilt adjuster 130 and armrests 135, 140. The seat height adjuster 125 may be located within arms-reach of a user, such as towards the side of an underside of the seat bottom 115. The seat height adjuster 125 may allow the user to adjust the height of the seat bottom 115, similar to a normal office chair. For example, the seat height adjuster 125 may be a lever configured to actuate a pneumatic gas lift built into the seatbase 110 to cause the seat bottom 115 to raise or lower in height.

The seat bottom 115 may be tiltable relative to the seatbase 110. The tilt adjuster 130 may increase or decrease the amount of force required to tilt the seat bottom 115 relative to the seatbase 110. The tilt adjuster 130 may be located on an underside of the seat bottom 115. The tilt adjuster 130 may be spring loaded. In one embodiment of the mobility assistance office chair 100, when a user applies force to the seat back 120, such as by leaning into the seat back 120, the seat back 120 and seat bottom 115 may tilt relative to the seatbase 110. The seat back 120 and seat bottom 115 may be connected in a set or moveable manner. The seat bottom and seat back comprise a seating portion of the mobility assistance office chair 100.

The armrests 135, 140 may be connected to sides of the seat back 120 and may be adjustable. The armrests 135, 140 may be adjustable by rotating up, down, inward, and/or outward, for example, upward to a vertical position to reduce obstruction to the user's arms when using the hand gripping portions 155, 160.

In a preferred embodiment, the mobility assistance office chair 100 may be used indoors and on relatively smooth, flat surface, though the mobility assistance office chair 100 may be used under other conditions. Users may propel themselves by scooting along with their feet or by manually rolling the second set of wheels 165, 170 by utilizing the hand gripping portions 155, 160, or both. Users may also move grab nearby furniture and doorways to pull their way through a room or around objects. Also, a caregiver can grasp the back of the mobility assistance office chair 100 and push or pull.

The mobility assistance office chair 100 may be desirable to people who do not wish to use a traditional mobility assistance office chair or are frequently in a business setting. The mobility assistance office chair 100 may be designed to look non-medical, to be distance from looking like a traditional wheelchair. This prevents the user from having any prejudice or stigma that might come from using a medical device so publically.

FIG. 1 also shows how the office chair may be

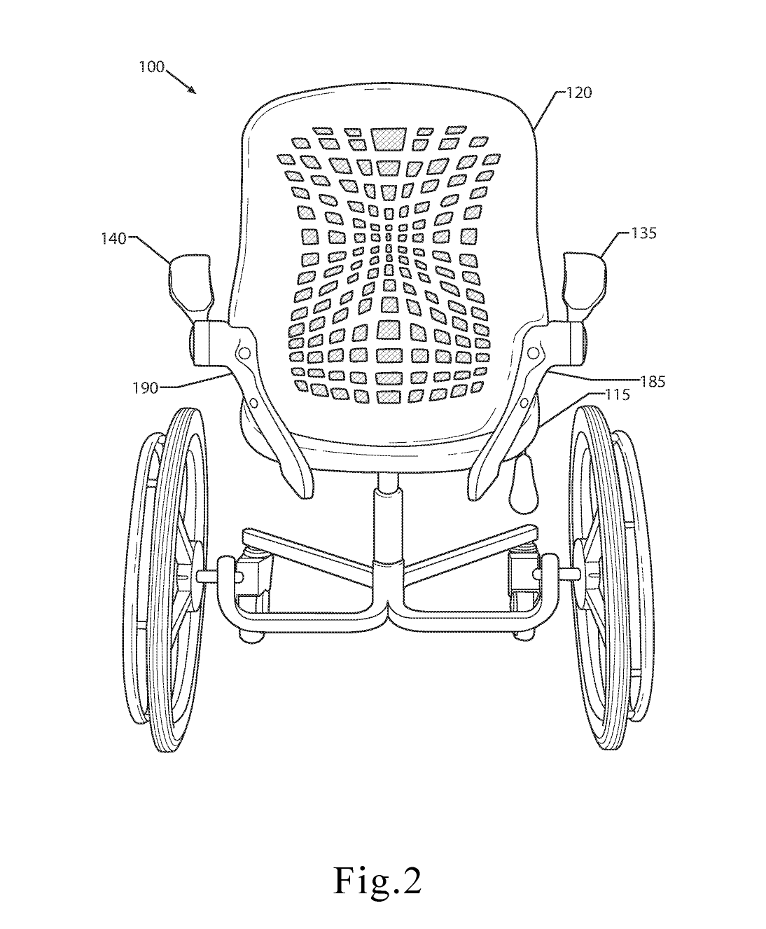

FIG. 2 is a rear view of one embodiment of a mobility assistance office chair. As shown in FIG. 2, the mobility assistance office chair 100 may comprise a seat back 120 and seat bottom 115. The seat back 120 and seat bottom 115 may be connected by connecting members 185, 190. The connecting members 185, 190 may also act as a connecting portion for the armrests 135, 140, and may be substantially rigid.

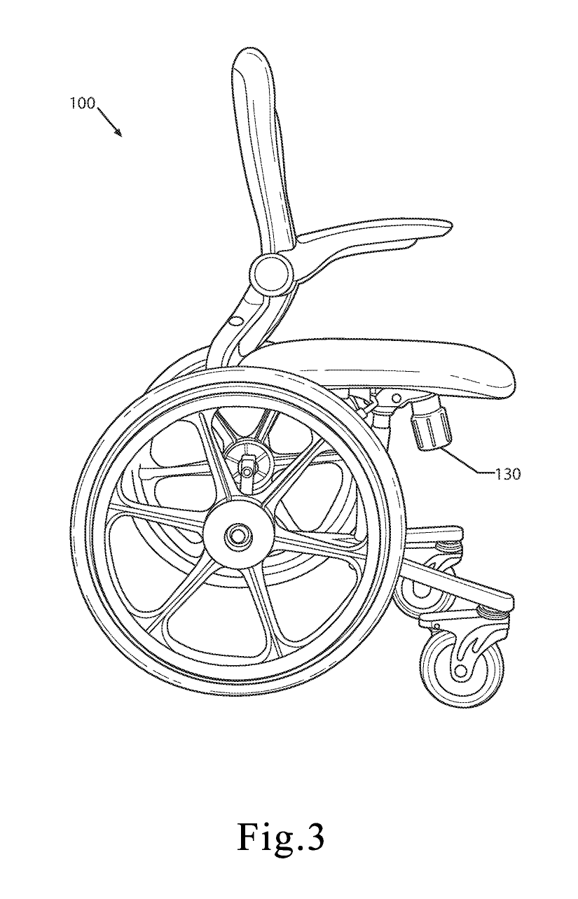

FIG. 3 is a side view of one embodiment of a mobility assistance office chair. And shows how the seat back may preferably have an ergonomic seat and seat back. FIG. 3 also shows how the user's legs would be unimpeded for assisting in mobility when a user is seated. FIG. 3 also shows the tilt adjuster 130.

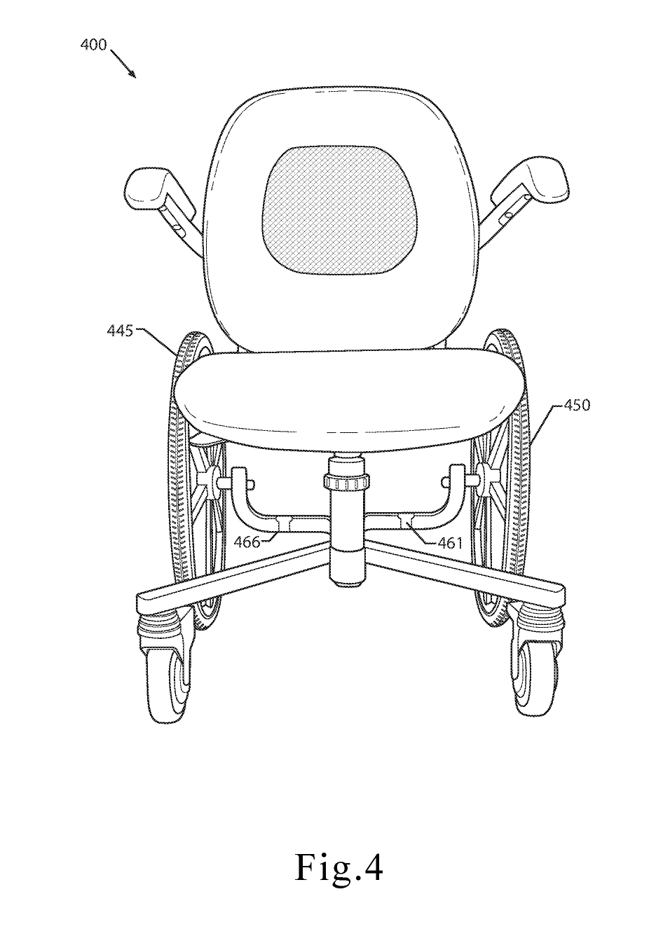

FIG. 4 is a front view of another embodiment of a narrow mobility assistance office chair. As shown in FIG. 4, the narrow mobility assistance office chair 400 may be substantially similar to the mobility assistance office chair 100 described in FIGS. 1-3. Importantly, the narrow mobility assistance office chair 400 may have a second set of wheels 445, 450 that are closer together than the second set of wheels 145, 150 of the mobility assistance office chair 100 described in FIGS. 1-3. Additionally, the arms 446, 461 of the narrow mobility assistance office chair 400 may be shorter in length than the arms 146, 161 of the mobility assistance office chair 100. One advantage of this relatively narrower configuration is that the narrow mobility assistance office chair 400 may allow a user entry into places with more narrow entryways, such as bathrooms and older buildings.

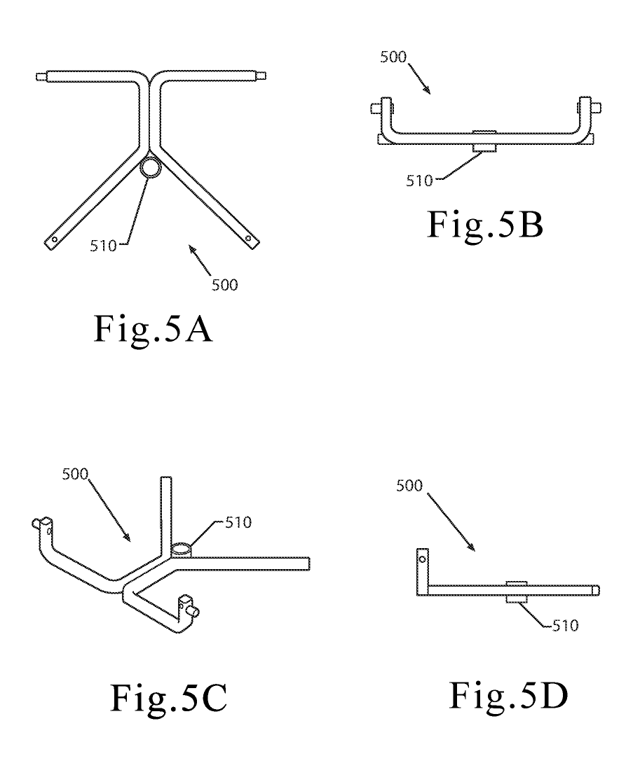

FIGS. 5A-D are different views of wheelbases for use with a mobility assistance office chair. FIGS. 5A-D show one embodiment of a wheelbase 500, analogous to the wheelbase 105 disclosed in FIG. 1. The wheelbase 500 may be welded to a seatbase 510. Additionally, the wheelbase 500 may comprise two shaped metal tubes welded or otherwise secured to one another.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. The disclosed embodiments capable of modifications in various obvious aspects, all without departing from the spirit and scope of the protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope. It is intended that the scope or protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A mobility assistance office chair, comprising:
a wheelbase;
a first set of wheels;
a second set of wheels;
a seatbase;
a seat bottom; and
a seat back;
wherein said first set of wheels and said second set of wheels are connected to said wheelbase;
wherein said seatbase is a substantially vertical and connects said wheelbase to said seat bottom;
wherein said seatbase, said seat bottom, and said wheelbase are substantially static with respect to each other, such that said seat bottom and said wheelbase do not rotate relative to each other;
wherein said second set of wheels has a radius that is long enough to allow a top portion of said second set of wheels to be within arm's reach of a user seated on said seat bottom, such that said user may manually use said second set of wheels to cause said mobility assistance office chair to move as powered by said user; and
wherein said seat back has an appearance of being an office chair seat back.

2. The mobility assistance office chair of claim 1, wherein said mobility assistance office chair is configured to allow a person with impaired mobility to be mobile within an office environment.

3. The mobility assistance office chair of claim 1, wherein said seat back is adjustable.

4. The mobility assistance office chair of claim 1, wherein said seat bottom is adjustable.

5. The mobility assistance office chair of claim 1, wherein said seat bottom height, relative to said wheelbase, is adjustable.

6. The mobility assistance office chair of claim 1, further comprising:
one or more arm rests;

7. The mobility assistance office chair of claim 6, wherein said one or more arm rests are adjustable.

8. The mobility assistance office chair of claim 1, wherein said wheelbase comprises four arms that are connected to said first set of wheels and said second set of wheels.

9. The mobility assistance office chair of claim 1, wherein said first set of wheels comprises a set of rotatable casters.

10. The mobility assistance office chair of claim 9, wherein said set of rotatable casters provides balance and support to said mobility assistance office chair, and wherein said second set of wheels substantially bears the weight of said mobility assistance office chair and said user when in use.

11. The mobility assistance office chair of claim 1, wherein said wheelbase is substantially horizontal and substantially cross-shaped.

12. The mobility assistance office chair of claim 1, wherein each wheel of said second set of wheels comprises a hand gripping portion.

13. A mobility assistance office chair, comprising:
a wheelbase;
a first set of wheels;
a second set of wheels;
a seatbase;
a seat bottom; and
a seat back;
wherein said first set of wheels and said second set of wheels are connected to said wheelbase;
wherein said seatbase is a substantially vertical and connects said wheelbase to said seat bottom;
wherein said seatbase, said seat bottom, and said wheelbase are substantially static with respect to each other such that said seat bottom and said wheelbase do not rotate relative to each other;
wherein said second set of wheels has a radius that is long enough to allow a top portion of said second set of wheels to be within arm's reach of a user seated on said seat bottom, such that said user may manually use said second set of wheels to cause said mobility assistance office chair to move as powered by said user;
wherein said seat back has an appearance of being an office chair seat back;
wherein said mobility assistance office chair allows a person with impaired mobility to be mobile within an office environment;
wherein said seat back is adjustable; and
wherein said seat bottom is adjustable.

14. The mobility assistance office chair of claim 13, further comprising:
one or more arm rests;

15. The mobility assistance office chair of claim 14, wherein said one or more arm rests are adjustable.

16. The mobility assistance office chair of claim 15, wherein said wheelbase comprises four arms that are connected to said first set of wheels and said second set of wheels.

17. The mobility assistance office chair of claim 16, wherein said first set of wheels comprises a set of rotatable casters.

18. The mobility assistance office chair of claim 17, wherein said set of rotatable casters provides balance and support, and wherein said second set of wheels substantially bears the weight of said mobility assistance office chair and said user when in use.

19. The mobility assistance office chair of claim 18, wherein each wheel of said second set of wheels comprises a hand gripping portions.

20. A mobility assistance office chair, comprising:
a wheelbase;
a first set of wheels;
a second set of wheels;
a seatbase;
an adjustable seat bottom;
one or more adjustable arm rests; and
an adjustable seat back;
wherein said first set of wheels and said second set of wheels are connected to said wheelbase;
wherein said seatbase is a substantially vertical and connects said wheelbase to said seat bottom;
wherein said seatbase, said seat bottom, and said wheelbase are substantially static with respect to each other such that said seat bottom and said wheelbase do not rotate relative to each other;
wherein said second set of wheels has a radius that is long enough to allow a top portion of said second set of wheels to be within arm's reach of a user seated on said seat bottom, such that said user may manually use said second set of wheels to cause said mobility assistance office chair to move as powered by said user;
wherein said seat back has an appearance of being an office chair seat back;
wherein said mobility assistance office chair allows a person with impaired mobility to be mobile within an office environment; and
wherein each wheel of said second set of wheels comprises a hand gripping portion.
